(19) United States
(12) Patent Application Publication
(10) Pub. No.: US 2016/0234602 A1
(43) Pub. Date: Aug. 11, 2016

(54) HYDROPHOBIC SPEAKER SYSTEMS

(71) Applicant: Mitek Corp., Inc., Phoenix, AZ (US)

(72) Inventor: Johnathan Ivey, Chandler, AZ (US)

(21) Appl. No.: 14/737,378

(22) Filed: Jun. 11, 2015

Related U.S. Application Data
(60) Provisional application No. 62/112,939, filed on Feb. 6, 2015.

(51) Int. Cl. H04R 9/06; H04R 9/02; H04R 9/04; H04R 1/02

(52) U.S. Cl. CPC H04R 9/06; H04R 1/023; H04R 9/025; H04R 9/043; H04R 9/045

(57) ABSTRACT

A speaker system having internal and external static and dynamic constituent speaker parts at least partially coated with a hydrophobic coating to prevent water or condensation accumulations that would interfere with performance. Objects associated with the speaker, such as a speaker grill, power supply, speaker support, or speaker enclosure may also be at least partially coated with a hydrophobic coating to prevent water or condensation accumulations that would interfere with performance.

### RELATED APPLICATIONS

This application claims the benefit of U.S. provisional patent application No. 62/112,939 filed Feb. 6, 2015 to the same inventor.

### FIELD OF ART

The present invention relates to a loudspeaker system having dynamic and static parts to which water or condensation cannot adhere. In particular, the invention relates to parts of the system that are at least partially coated with a hydrophobic coating.

### BACKGROUND OF THE INVENTION

“Amathophobia” is the fear of water or condensation. Hydrophobic coatings are coatings to which water or condensation does not adhere. Loudspeakers undesirably accumulate water or condensation that can degrade speaker performance and sound quality. For example, a foraminous speaker grill can become clogged with water or condensation which dampens the sound to the listener. For further example, water or condensation can accumulate on dynamic surfaces, such as the spider, the coil, the surround, or the diaphragm. Such accumulations can change the mass of the part to which the water or condensation attaches, thereby affecting system dynamics and degrading sound quality. For a further example, electrical contacts for the speaker inputs may be bridged by water or condensation, thereby affecting the circuit and degrading sound quality. For another example, the air gap of a loudspeaker may accumulate water or condensation, thereby changing the volume of the air gap and so the dynamics of the coil.

### SUMMARY OF THE INVENTION

Briefly described, the invention includes a speaker system having at least one of internal and external static and dynamic constituent speaker parts at least partially coated with a hydrophobic coating to prevent water or condensation accumulations that would interfere with performance. Objects associated with the speaker, such as a speaker grill, power supply, speaker support, or speaker enclosure may also be at least partially coated with a hydrophobic coating to prevent water or condensation accumulations that would interfere with performance.

### DESCRIPTION OF THE FIGURES OF THE DRAWINGS

The present invention will hereinafter be described in conjunction with the following drawing figures, wherein like numerals denote like elements, and

FIG. 1 is a plan view illustrating an exemplary embodiment of an exemplary speaker grill, according to a preferred embodiment of the present invention;

FIG. 2 is a front perspective view illustrating an exemplary embodiment of a detail of the speaker grill of FIG. 1, according to a preferred embodiment of the present invention;

FIG. 3 is a front perspective cutaway view illustrating an exemplary embodiment of the water or condensation free speaker system, according to a preferred embodiment of the present invention;

FIG. 4 is an exploded perspective view illustrating another exemplary embodiment of the water or condensation free speaker system, according to a preferred embodiment of the present invention; and

FIG. 5 is a front perspective view illustrating another exemplary embodiment of the water or condensation free speaker system, according to a preferred embodiment of the present invention.

### DETAILED DESCRIPTION OF THE INVENTION

As used and defined herein, “speaker” is means an audio loudspeaker.

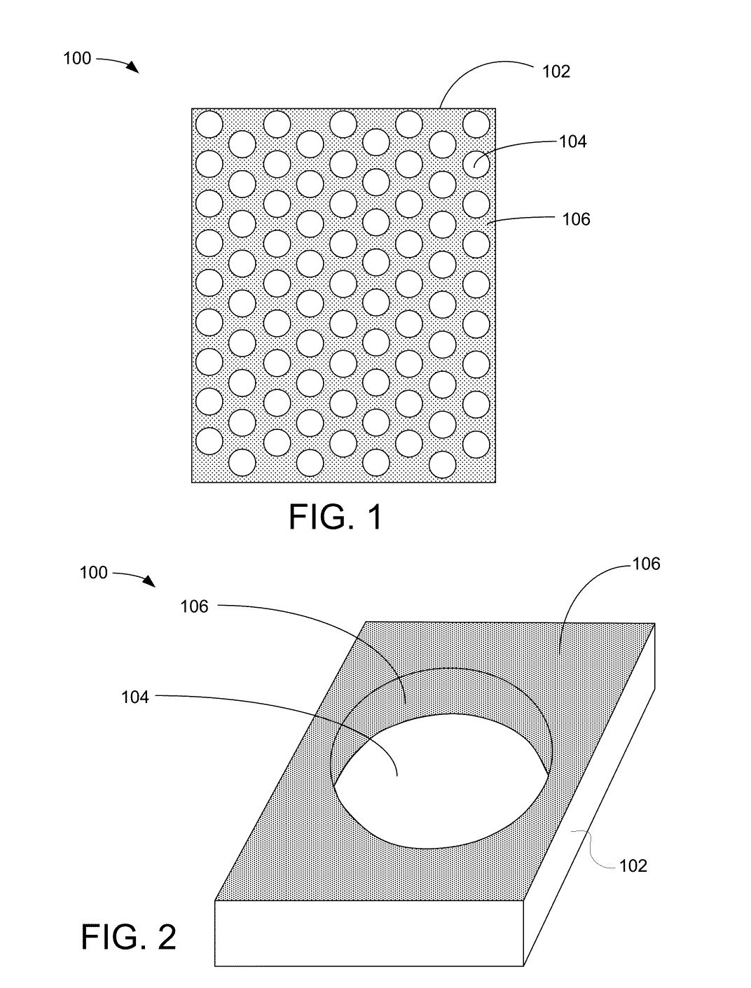

FIG. 1 is a plan view illustrating an exemplary embodiment of an exemplary hydrophobic speaker grill 100, according to a preferred embodiment of the present invention. Speaker grill 100 is a foraminous panel 102 having multiple foramina (holes) 104 for the passage of sound. Panel 102 has an hydrophobic coating 106 on both sides of speaker grill 102. The coating may be, for non-limiting example, that described in US Published Patent Application US20060286305 A1 or equivalent commercially available hydrophobic (water or condensation-free) coating 106. While panel 102 is illustrated as flat and rectangular, the invention is not so limited. In additional embodiments, panel 102 may be curved, multiply curved, or angled and may have a perimeter of any desired shape. The spacing, sizing, and shape parameters of foramina 104 are determined based on speaker dynamics (frequency range, power, etc.), and the foramina parameters must be adjusted to account for the hydrophobic coating 106. The hydrophobic coating may also be amathophobic and/or oleophobic.

FIG. 2 is a front perspective view illustrating an exemplary embodiment of a detail of the speaker grill 100 of FIG. 1, according to a preferred embodiment of the present invention. The hydrophobic coating 106 is applied to the bore surfaces of the foramina 104 in addition to both sides of panel 102. Accordingly, the sizes, shapes, and spacing of the foramina, when initially formed in panel 102, must take into account the thickness of the hydrophobic coating 106 to be applied. For some hydrophobic coatings 106, a layer is deposited and then reduced by wiping or use of a squeegee. For non-limiting example, for the inner walls of the foramina 104, the same drilling jig and CAM program used to drill the holes 104 can be used to reduce the coating 106 within the foramina by using a smaller drill bit.

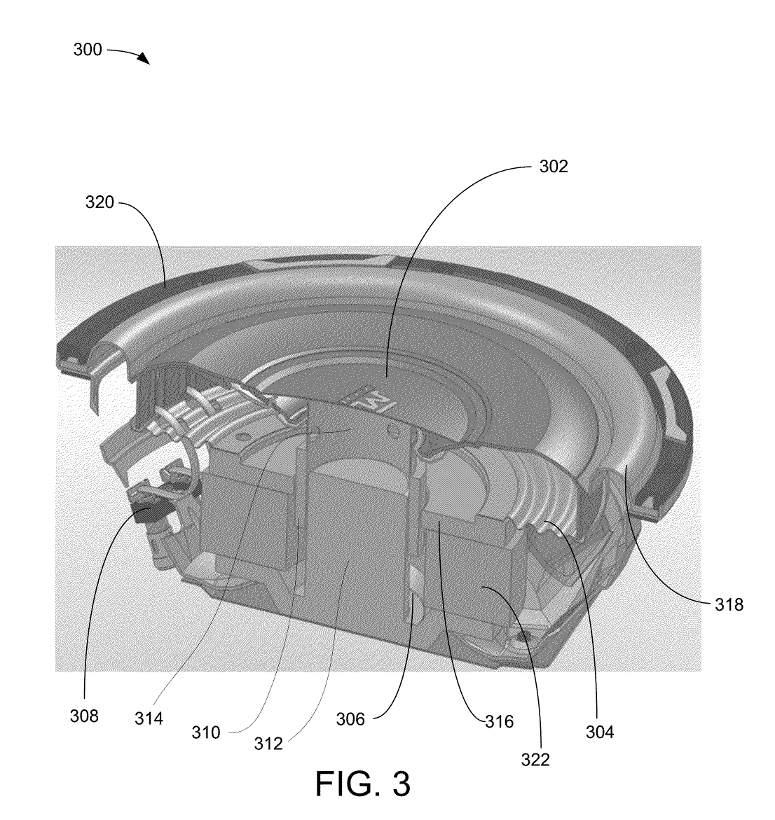

FIG. 3 is a front perspective cutaway view illustrating an exemplary embodiment of a hydrophobic speaker system 300, according to a preferred embodiment of the present invention. Loudspeaker 300 includes a number of constituent parts including a diaphragm 302, a surround 314, and a basket 318 (illustrated by the rim of the basket). A diaphragm 302 sometimes includes a central cap which, for present purposes, will be regarded as part of the diaphragm 302. With the top of diaphragm 302, the top of surround 314, and the top of basket 318 rim coated with hydrophobic coating 106, the entire acoustic face of the speaker is made water. Such a speaker 300 may have both general application and also particular application in marine or rainforest environments. In particular embodiments, additional areas of hydrophobic coating 106 may be used on additional portions of the diaphragm 302, surround 314, and basket 318, adaptive to anticipated use environments and speaker design.

Loudspeaker 300 also includes a former 314, a coil 310, and a spider 304, all of which are internal dynamic constituent parts. Coating the interior of the former 314 with hydrophobic coating 106 reduces water or condensation accumulation between the former 314 and the central magnetic pole piece 312, thereby assisting in keeping air gap 306 unobstructed. Coil 310 is wound on former 314 and also oscillates in air gap 306, so a hydrophobic coating 106 on coil 310 will also assist in keeping air gap 306 unobstructed. Spider 304 preferably has hydrophobic coating 106 on both sides, as the spider 304 is a spring in a spring-mass-damper system and changes to its mass properties, as by water or condensation accumulation, can affect speaker 300 performance.

Loudspeaker 300 also includes magnetic materials as constituent parts, including magnet 322, pole piece 312, and air gap plate 316. Pole piece 312 and air gap plate 316 conduct magnetic lines of force from magnet 322. Hydrophobic coating 106 on portions of surfaces of magnetic materials that form the air gap 306 will assist in keeping the air gap 306 free of water or condensation.

Loudspeaker 300 also includes electrical contacts 308, each of which is coated with hydrophobic coating 106 to prevent bridging of the contacts by water or condensation. For each of the external dynamic constituent parts (the diaphragm 302 and the surround 304) and the internal dynamic constituent parts (former 314, coil 310, and spider 304), the effect of the hydrophobic coating 106 on the acoustics of the speaker 300 must be determined and the design of the speaker 300 adapted to accommodate the effects.

The air gap 306 is preferably coated on all interior surfaces. The sizing of the elements making up the air gap must be adapted to ensure proper clearances after hydrophobic coating 106 is applied. The entire circumferential surface of the central magnetic pole piece 312 may be beneficially coated to prevent water or condensation accumulation between the pole piece 312 and the former 314 on which the coil 310 is wound. The electrical contacts 308 are coated peripherally to avoid interfering with electrical connections but preventing a water or condensation bridge from forming. The scope of the invention covers a loudspeaker with at least one hydrophobic coated constituent part as well as each hydrophobic coated part.

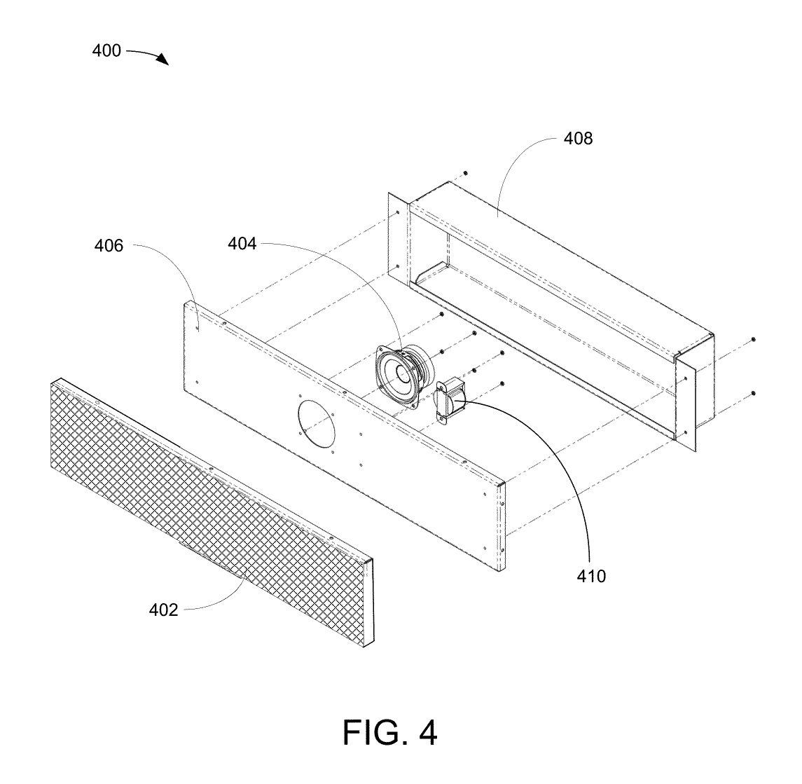

FIG. 4 is an exploded perspective view illustrating another exemplary embodiment of a hydrophobic speaker system 400, according to a preferred embodiment of the present invention. Foraminous speaker grill 402 does not attach directly to speaker 404 but is coated as described in relation to FIGS. 1 and 2. Speaker 404 is coupled to speaker support panel 406 and grill 402 is fastened to speaker support panel 406, which itself is fastened to speaker enclosure 408. Speaker support panel 406 is exemplary of a wide variety of speaker supports that may benefit from an hydrophobic coating 106. Speaker 404 may be speaker 300 with its hydrophobic coatings 106. Power supply 410 is attached to speaker 404 via speaker support panel 406 and may also have an hydrophobic coating 106, at least around its electrical contacts, to prevent water or condensation bridging. Ceiling speaker installations like hydroophobic speaker system 400 may be in place for decades, and water or condensation accumulations over such a time span can be large. FIG. 4 illustrates that hydrophobic coated objects of the hydrophobic speaker system 400 do not have to be within, or be directly attached to, speaker 404.

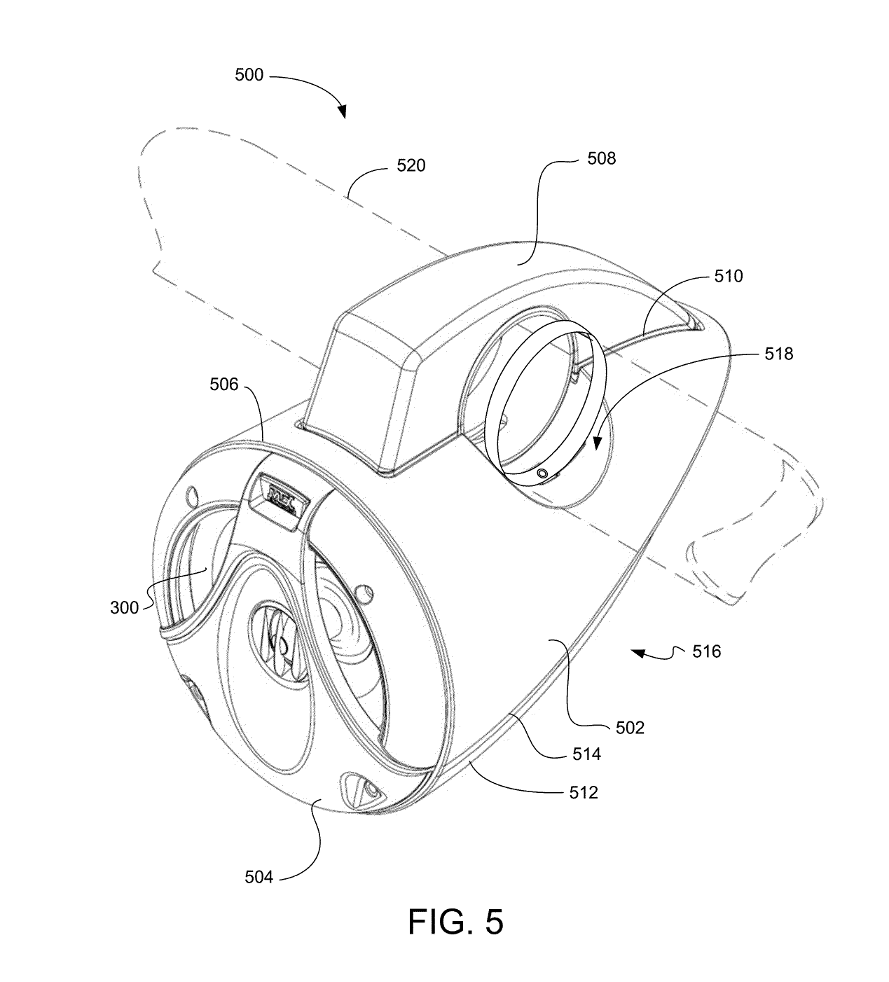

FIG. 5 is a front perspective view illustrating another exemplary embodiment of the hydrophobic speaker system 500, according to a preferred embodiment of the present invention. Hydrophobic speaker system 500 is designed for marine environments and includes hydrophobic speaker 300 with at least the exterior surfaces of the surround 318 and diaphragm 302 coated with hydrophobic coating 106, and with any exposed portion of the basket 320 also coated. Hydrophobic speaker system 500 also includes speaker enclosure 516, speaker grill 504 and speaker support 508. Preferably, speaker grill 504 is coated with hydrophobic coating 106. Additional preferred portions for application of hydrophobic coating 106 includes seam 514 between upper 502 and lower 512 halves of speaker enclosure 516, seam 506 between speaker grill 504 and upper 502 and lower 512 halves of speaker enclosure 516. Seam 510 between upper half 502 of speaker enclosure 516 and speaker support 508 is not formed until installation, and so cannot be prepared with hydrophobic coating at the factory. As an example of a disfavored location for hydrophobic coating 106, surface 518 is identified. Surface 518 receives and abuts crossbar 520, causing compression of surface 518. The combination of compression and vibration from sound or boat motion would destroy the hydrophobic coating 106.

While applicant has provided exemplary embodiments, the invention is not so limited, but includes embodiments that apply to a wide variety of speaker designs, constituent parts, and associated objects.

I claim:

1. An hydrophobic speaker assembly comprising:
a. at least one constituent part of a speaker; and
b. an hydrophobic coating at least partially coating at least one of:
i. at least a portion of said constituent part; and
ii. at least a portion of an object configured to be associated with said at least one constituent part by attachment.

2. The hydrophobic speaker assembly of claim 1, wherein said attachment comprises direct attachment.

3. The hydrophobic speaker assembly of claim 1, wherein said at least one constituent part of a speaker comprises a diaphragm.

4. The hydrophobic speaker assembly of claim 1, wherein said at least one constituent part of a speaker comprises a spider.

5. The hydrophobic speaker assembly of claim 1, wherein said at least one constituent part of a speaker comprises a coil.

6. The hydrophobic speaker assembly of claim 1, wherein said at least one constituent part of a speaker comprises an electrical coupling.

7. The hydrophobic speaker assembly of claim 1, wherein said at least one constituent part of a speaker comprises a magnetic material.

8. The hydrophobic speaker assembly of claim 1, wherein said at least one object associated configured to be associated with said at least one constituent part comprises a speaker grill.

9. The hydrophobic speaker assembly of claim 8, wherein said hydrophobic coating at least partially coating a portion of said speaker grill comprises said hydrophobic coating on inner surfaces of foramina in said speaker grill.

10. The hydrophobic speaker assembly of claim 1, wherein said at least one object associated configured to be associated with said at least one constituent part comprises a speaker housing.

11. The hydrophobic speaker assembly of claim 1, wherein said at least one object associated configured to be associated with said at least one constituent part comprises a power supply.

12. An hydrophobic speaker assembly comprising:
a. at least one constituent part of a speaker; and
b. an hydrophobic coating at least partially coating at least one of:
i. at least a portion of said constituent part; and
ii. at least a portion of an object configured to be associated with said at least one constituent part by attachment; and
c. wherein said at least one constituent part of a speaker comprises at least one of:
i. a diaphragm;
ii. a spider;
iii. a coil;
iv. a former;
v. an electrical connection;
vi. a magnetic material;
vii. a basket; and
viii. a surround.

13. The hydrophobic speaker assembly of claim 12, wherein said at least one object associated configured to be associated with said at least one constituent part comprises a speaker grill.

14. The hydrophobic speaker assembly of claim 13, wherein said hydrophobic coating at least partially coating at least a portion of said speaker grill comprises said hydrophobic coating on inner surfaces of foramina in said speaker grill.

15. The hydrophobic speaker assembly of claim 12, wherein said at least one object associated configured to be associated with said at least one constituent part comprises at least one of a speaker enclosure, a speaker support, and a power supply.

16. An hydrophobic speaker assembly comprising:
a. at least one constituent part of a speaker; and
b. an hydrophobic coating at least partially coating at least one of:
i. at least a portion of said constituent part; and
ii. at least a portion of at least one object configured to be associated with said at least one constituent part by attachment; and
c. wherein said at least one object comprises at least one of:
i. a speaker grill;
ii. a speaker enclosure;
iii. a speaker support; and
iv. a power supply.

17. The hydrophobic speaker assembly of claim 16, wherein said hydrophobic coating hydrophobic coating at least partially coating at least a portion of said at least one object comprises said hydrophobic coating on inner surfaces of foramina in said speaker grill.

18. The hydrophobic speaker assembly of claim 16, wherein said at least one constituent part of a speaker comprises at least one of a diaphragm, a surround, and a basket.

19. The hydrophobic speaker assembly of claim 16, wherein said at least one constituent part of a speaker comprises at least one of a former, a coil, and a spider.

20. The hydrophobic speaker assembly of claim 16, wherein said at least one constituent part of a speaker comprises at least one of a magnetic material and an electrical connection.
